(19) United States
(12) Patent Application Publication
(10) Pub. No.: US 2025/0068935 A1
(43) Pub. Date: Feb. 27, 2025

(54) MODEL PROCESSING METHOD, APPARATUS, DEVICE AND MEDIUM

(71) Applicant: Beijing Youzhuju Network Technology Co., Ltd., Beijing (CN)

(72) Inventor: Yukun MA, Vancouver (CA)

(21) Appl. No.: 18/814,316

(22) Filed: Aug. 23, 2024

(30) Foreign Application Priority Data
Aug. 25, 2023 (CN) 202311080864.4

(51) Int. Cl. G06N 5/01; G06N 5/022

(52) U.S. Cl. CPC G06N 5/01; G06N 5/022

(57) ABSTRACT

Methods, apparatuses, devices, and media for model processing are provided. In an approach, a first knowledge domain in the field of general knowledge involved in a processing model is determined. A first set of reference queries associated with the first knowledge domain is generated. A first set of reference answers matching the first set of reference queries is obtained from a repository that is associated with the processing model and at least relates to the first knowledge domain. The processing model is updated by using the first set of reference queries and the first set of reference answers. With the implementations of the disclosure, the knowledge reserve in various subdivided knowledge domains can be continuously added to the processing model. The processing model can improve performance and accuracy in this way, providing more accurate query result output.

### CROSS-REFERENCE

The present application claims priority to Chinese Patent Application No. 202311080864.4, filed on Aug. 25, 2023 and entitled “MODEL PROCESSING METHOD, APPARATUS, DEVICE AND MEDIUM”, the entirety of which is incorporated herein by reference.

### FIELD

Example implementations of the present disclosure generally relate to machine learning techniques, and in particular, to methods, apparatuses, devices, and computer-readable storage media for model processing.

### BACKGROUND ART

Machine learning techniques have been widely applied to perform a variety of processing tasks, for example, a variety of processing model may be constructed to perform various processing tasks, and a query may be sent to the processing model and a query result from the processing model may be received. The processing model should have knowledge in numerous knowledge domains to provide accurate results for queries in different knowledge domains. However, the failure of processing model to cover all knowledge domains results in its inability to provide accurate query results in some cases (e.g. when involving a certain subdivided knowledge domain) and, in this case, it is desirable to obtain a more accurate and comprehensive processing model.

### SUMMARY

In a first aspect of the present disclosure, a model processing method is provided. In the method, a first knowledge domain in the general knowledge domain involved in a processing model is determined. A first set of reference queries associated with the first knowledge domain is generated. A first set of reference answers matching the first set of reference queries is obtained from a repository that is associated with the processing model and at least relates to the first knowledge domain. The processing model is updated by using the first set of reference queries and the first set of reference answers.

In a second aspect of the present disclosure, a model processing apparatus is provided. The apparatus includes a determining module configured to determine a first knowledge domain in a general knowledge domain involved in a processing model; a generating module configured to generate a first set of reference queries associated with the first knowledge domain; an obtaining module configured to obtain a first set of reference answers matching the first set of reference queries from a repository associated with the processing model, the repository at least involving the first knowledge domain; and an updating module configured to update the processing model based on the first set of reference queries and the first set of reference answers.

In a third aspect of the present disclosure, an electronic device is provided. The electronic device includes at least one processing unit, and at least one memory coupled to at least one processing unit and storing instructions for execution by at least one processing unit, and the instructions, when executed by at least one processing unit, cause the electronic device to execute the method according to the first aspect of this disclosure.

In a fourth aspect of the present disclosure, there is provided a computer-readable storage medium having stored thereon a computer program which, when executed by a processor, causes the processor to implement the method according to the first aspect of the present disclosure.

It should be understood that the content described herein is not intended to limit key or important features of implementations of the present disclosure, nor to limit the scope of the present disclosure. The other features disclosed herein will become readily understood through the following description.

### BRIEF DESCRIPTION OF DRAWINGS

The above and other features, advantages, and aspects of the various implementations of the present disclosure will become more apparent from the following detailed description when taken in conjunction with the accompanying drawings in which, the same or similar reference numbers refer to the same or similar elements, wherein:

FIG. 1 shows a block diagram of an application environment of a processing model according to an example implementation of the present disclosure;

FIG. 2 shows a block diagram of a process of model processing according to some implementations of the present disclosure;

FIG. 3 shows a block diagram of a query type according to some implementations of the present disclosure;

FIG. 4 shows a block diagram for generating a reference sample according to some implementations of the present disclosure;

FIG. 5 shows a block diagram for generating reference samples associated with a given knowledge domain, according to some implementations of the present disclosure;

FIG. 6 shows a block diagram of reference samples associated with generating various knowledge domains within a general knowledge domain, according to some implementations of the present disclosure;

FIG. 7 shows a block diagram for updating a processing model according to some implementations of the present disclosure;

FIG. 8 shows a block diagram for processing a user query with an updated processing model, according to some implementations of the present disclosure;

FIG. 9 shows a flowchart of a model processing method according to some implementations of the present disclosure;

FIG. 10 shows a block diagram of a model processing apparatus according to some implementations of the present disclosure; and

FIG. 11 shows a block diagram of a device capable of implementing various implementations of the present disclosure.

### DETAILED DESCRIPTION

Implementations of the present disclosure will be described in more detail below with reference to the accompanying drawings. Although certain implementations of the present disclosure are shown in the accompanying drawings, it should be understood that the present disclosure may be implemented in various forms and should not be construed as limited to the implementations set forth herein, but rather, these implementations are provided for a more thorough and complete understanding of the present disclosure. It should be understood that the drawings and implementations of the present disclosure are for illustrative purposes only and are not intended to limit the scope of the present disclosure.

In the description of implementations of the present disclosure, the terms “include” and similar terms should be understood as an open inclusion, that is, to include “including but not limited to”. The term “based on” should be understood as “based at least in part on”. The terms “one implementation” or “the implementation” should be understood as “at least one implementation”. The term “some implementations” should be understood as “at least some implementations”. Other explicit and implicit definition may also be included below. As used herein, the term “model” may represent an association relationship between various data, for example, the association relationship may be obtained based on various technical solutions currently known and/or to be developed in the future.

It may be understood that the data involved in the technical solution (including but not limited to the data itself, the acquisition or use of the data) should follow the requirements of the corresponding laws and regulations and related regulations.

It can be understood that, prior to the use of the technical solutions disclosed in the embodiments of the present disclosure, the types of personal information related to the present disclosure, the usage scope, the usage scenario and the like should be notified to the user in an appropriate manner according to the relevant laws and regulations, and authorization should be obtained from the user.

In response to receiving an active request from a user, for example, prompt information is sent to the user to explicitly prompt the user that the requested operation will need to obtain and use the personal information of the user. Therefore, the user can, according to the prompt information, autonomously select whether to provide personal information to the software or hardware executing the technical solution of the present disclosure.

As an optional but non-limiting implementation, in response to receiving an active request of the user, prompt information can be sent to the user, for example, by a pop-up window in which prompt information may be presented in a text manner. In addition, the pop-up window may further have a selection control for the user to select “Agree” or “Disagree” to provide personal information to the electronic device.

It may be understood that the foregoing notification and obtaining a user authorization is merely illustrative and does not constitute a limitation on implementations of the present disclosure, and other ways that meet related laws and regulations may also be applied to the implementations of the present disclosure.

The term “in response to” as used herein means a state in which a respective event occurs or condition is satisfied. It is understood that the timing of a subsequent action performed in response to the event or condition is not necessarily highly correlated with the time at which the event occurs or the condition holds. In some cases, for example, subsequent actions may be performed immediately when an event occurs or a condition holds; while in other cases, subsequent actions may be performed after a period of time elapses after an event occurs or a condition holds.

### Example Environment

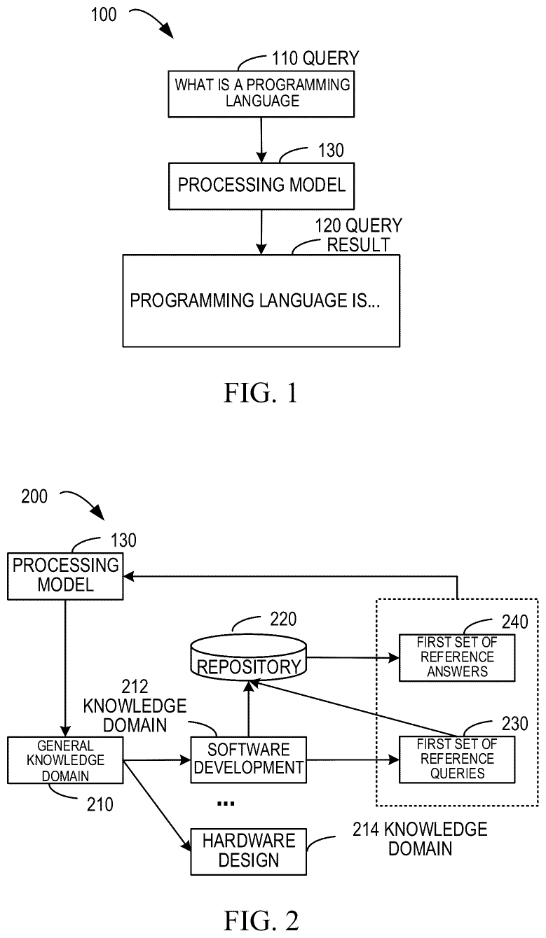

Machine learning techniques have been widely applied to perform a variety of processing tasks, for example, a variety of processing model may be constructed to perform various processing tasks. A query may be sent to the processing model and a query result from the processing model may be received. Refer to FIG. 1 to describe the application environment according to an example implementation method disclosed herein, FIG. 1 shows a block diagram 100 illustrating an application environment of a processing model according to an example implementation of the present disclosure. As shown in FIG. 1, the processing model 130 may be constructed in advance, and the query 110 may be input to the processing model 130. In the context of a language processing model, for example, the query 110 may be “what is a programming language”, and so on. At this point, the processing model 130 may provide a query result 120 that matches the query 110 to interpret the meaning of programming language.

The processing model 130 should have knowledge in numerous knowledge domains to provide accurate query results for query in different knowledge domains. However, the processing model 130 generally cannot cover all knowledge domains, as a result the processing model 130 in some cases (e.g. when involving a certain subdivided knowledge domain) cannot provide accurate query results, for example, the results output by the processing model 130 may not exactly match the input data, and a query result may be inaccurate when a large deep learning model (such as a Large Language model (LLM), or other models, etc.) is called.

Generally, a large pre-trained model, which itself has been trained by a large amount of data, can answer and solve the knowledge question answering task in most public domains, but the performance in a certain subdivided domain (also called the vertical domain) may not be satisfactory, generally, mainly because that no training data in the relevant subdivided domain is obtained during the training process. In order to obtain a model with a better performance in a certain subdivided domain, the data in the subdivided domain needs to be fine-tuned on the basis of a pre-trained model. Integrating subdivided domain knowledge is therefore critical, which helps to improve the problem understanding and processing capabilities of the model in a particular domain. The important implications of fine tuning process is reflected in the following aspects.

Domain expertise and depth: in understanding and processing specific domain problems, a large pre-trained model that is fused with subdivided domain knowledge can reflect higher expertise and depth. Such models can more accurately understand terms, concepts, and contextual relationships within the domain as compared to pre-trained generic model, among others.

Improving model performance: by integrating the subdivided domain knowledge for the model, in the fine-tuning stage, the model can better learn the subdivided domain expertise, thus obtaining better performance on related tasks in the subdivided domain.

Actual application value: In a real scenario, many applications are concentrated in a specific subdivided domain, and a model with subdivided domain knowledge can better meet the needs of these specific applications. The model that is fused with knowledge in software development domain, for example, can give more accurate and high-quality results when performing tasks such as term query and error diagnosis.

Reducing generalization error: the integration of subdivided domain knowledge helps to improve the domain generalization capability of the model, because the model may better understand and process related problems in a specific domain knowledge system, thus reducing the generalization error.

Enhancing model robustness: pre-trained models can better cope with some challenging problems with the support of domain knowledge, and the model with domain knowledge may exhibit higher robustness in face with complex, semantically similar or highly ambiguous tasks.

In order to expand the domain knowledge of the pre-trained model, it is currently proposed to collect and construct training data in the subdivided domain knowledge based on an artificial manner to perform the training method, however, the technical solution faces a large amount of manual labor and lower efficiency. At this point, it is desirable to train the machine learning model in a more efficient manner and to enable the machine learning model to process queries within each knowledge domain with higher performance and accuracy.

### Summary of Model Processing

In order to at least partially solve the deficiencies in the prior art, a model processing method is proposed according to an example implementation of the present disclosure. In general, the pre-trained processing model can be trained using reference samples constructed from knowledge in subdivided knowledge domains 130. In this way, the knowledge reserve of the processing model 130 in each subdivided knowledge domain is further enriched on the basis of the knowledge in the general knowledge domain that is originally possessed by the processing model 130, thus improving the performance and accuracy of the processing model 130, so that the query result output by the processing model 130 is more consistent with the query input by the user.

Referring to FIG. 2, a summary is described according to an example implementation of the present disclosure, and FIG. 2 shows a block diagram 200 of a process of model processing according to some implementations of the present disclosure. As shown in FIG. 2, the processing model 130 may be a pre-trained model that has various knowledge in the general knowledge domain 210. Specifically, the general knowledge domain 210 may be further subdivided into multiple knowledge domains, for example, knowledge domain 212 relates to software development, knowledge domain 214 relates to hardware design, and so on. Similar processing may be performed for each subdivided knowledge domain to obtain reference samples in each knowledge domain. In further, the processing model 130 may be updated using the obtained reference samples.

In the following, description is provided only with the knowledge domain 212 as an example. As shown in FIG. 2, the knowledge domain 212 (referred to as the first knowledge domain for ease of description) in the general knowledge domain 210 involved in processing model 130 may be determined. A first set of reference queries 230 associated with the knowledge domain 212 may be generated. It should be understood that a set of reference queries 230 may include one or more reference queries, for example, user questions in the field of software development may be determined, and reference query are constructed using these questions. Alternatively, and/or additionally, the reference query may be constructed by data retrieval or the like.

The reference query may be expressed in natural language, for example, “what is the programming language?”. Alternatively, and/or additionally, the reference query may have a predetermined format, for example, “Please explain: programming language”. The part in front of the colon, “please explain”, represents the type of action to be performed, and the part behind the colon, “programming language”, represents the object to be interpreted, and so on.

In further, a first set of reference answers 240 matching the first set of reference queries 230 may be obtained from the repository 220 and, here, the repository 220 is associated with the processing model 130 and may include knowledge within one or more knowledge domains in the general knowledge domain 210. Specifically, the repository 220 may relate to at least knowledge domain 212 and in this way, an answer matching each of the first set of reference queries 230 may be obtained from the repository 220, respectively.

Assuming that one reference query in the first set of reference queries 230 is “please explain: programming language”, the result that matches the reference query may be searched in the repository 220, for example, “Programming Language is . . . ”. Other reference query in the first set of reference queries 230 may be processed in a similar manner and corresponding reference answers are obtained. In further, the processing model 130 may be updated using the first set of reference queries 230 and the first set of reference answers 240.

With the example implementations of the present disclosure, the knowledge reserve in various subdivided knowledge domains can be continuously added to the processing model 130. The performance and accuracy of the processing model 130 can be improved in this way, so that the query result output by the processing model 130 is more consistent with the query input by the user.

### Detailed Process of Model Processing

A summary according to an example implementation disclosed herein is described, and more details will be provided below for determining reference queries and reference answers. It should be understood that the query may involve multiple types, and at this time, a corresponding reference query may be separately constructed for each query type. First, it is necessary to set the problems that the updated processing model 130 is expected to solve and in further, relevant data may be collected based on this setting and a corresponding reference query constructed. Taking the field of software development as an example, it is assumed that the problems that the processing model 130 is expected to answer relate to the following:

Technical query: mainly the queries on various latest technologies in relevant technical field, for example, including concept explanation (e.g., what is a programming language, etc.), information retrieval (e.g., searching related technical documents), knowledge summary (e.g., key analysis), and the like. Case analysis: For example, for a specific case faced by a user, a solution is provided to the case according to a corresponding technique. Problem diagnosis: A reasonable diagnosis is provided mainly for the corresponding problem faced by a user during software development, and so on. Based on the above problems, corresponding answers may be looked up in the repository 220.

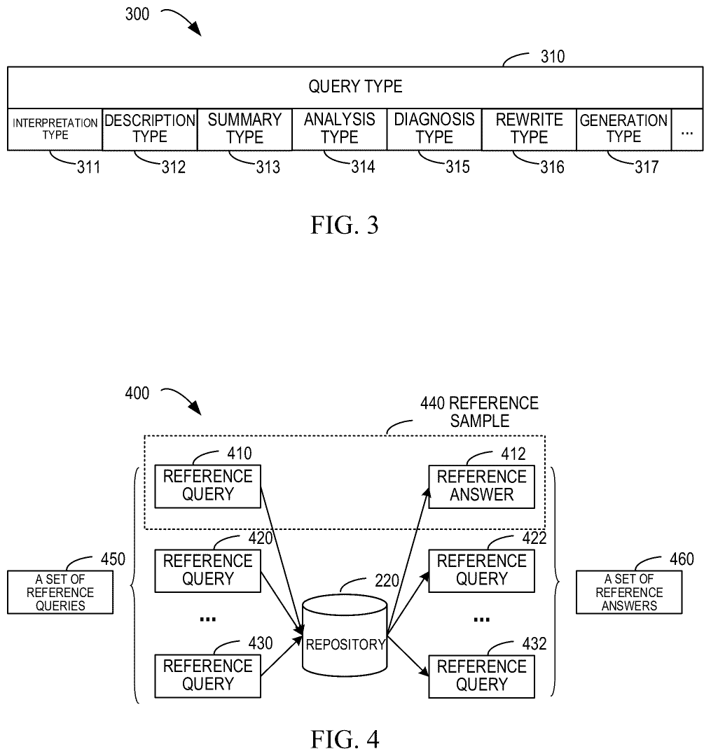

According to an example implementation of the present disclosure, the query may relate to different types. Referring to FIG. 3, a plurality of query types in the context of the present disclosure are described, and FIG. 3 shows a block diagram 300 of a query type according to some implementations of the present disclosure. As shown in FIG. 3, the query type 310 may include at least one of the following: interpretation type 311, description type 312, summary type 313, analysis type 314, diagnosis type 315, rewrite type 316, generation type 317, and so on.

According to an example implementation of the present disclosure, the query type 310 shown in FIG. 3 may vary according to a service requirement. As shown in FIG. 3, the interpretation type 311 and description type 312 are primarily used to inject subdivided domain knowledge into the processing model 130, so that the processing model 130 can leverage knowledge in these subdivided domains during inference. This query type typically enables processing model 130 to learn corresponding domain knowledge through instructions such as definition, interpretation, and description. Where a fine-tuning process is performed with such reference queries and corresponding reference answers, the updated processing model 130 may process interpretation and/or description type tasks.

The summary type 313 is mainly used to guide processing model 130 to summarize the subdivided domain knowledge and enable the user to quickly obtain the desired query result without reading a large number of documents. Where a training process is performed with such reference queries and corresponding reference answers, the updated processing model 130 may process summary type tasks. The analysis type 314 is mainly based on Chain of Thought (CoT) so that the processing model 130 obtains a certain reasoning ability, thereby providing a better reasoning effect in specific case analysis. Where a fine-tuning process is performed with such reference queries and corresponding reference answers, the updated processing model 130 may process the task of analysis type.

Diagnosis type 315 is mainly used to guide processing model 130 to find the root cause of the problem through the cases, that is, the reasoning capability and inducing and summarizing capability for training the processing model 130. When the fine-tuning process is performed by using such reference queries and corresponding reference answers, the updated processing model 130 may process diagnosis type tasks. The rewrite type 316 is used to guide the processing model 130 to complete rewriting in different styles. When the fine-tuning process is performed by using such reference queries and corresponding reference answers, the updated processing model 130 may process diagnosis type tasks. The generation type 317 is mainly used to guide the processing model 130 to generate content required by the user, for example, generation texts, images, and the like. When the fine-tuning process is performed by using such reference queries and corresponding reference answers, the updated processing model 130 may process generation type the tasks.

In the above types, the interpretation type and description type are basic methods for obtaining domain knowledge, the analysis type, summary type and diagnosis type are the basic learning tasks for a model to infer domain knowledge, and the generation type can output learning tasks to users based on learned domain knowledge. Different query types correspond to different types of tasks, and the processing model may continually enhance various processing capabilities based on these tasks.

According to an example implementation of the present disclosure, in various knowledge domains, a target type (for example, any type shown in FIG. 3) used for inputting a query to the processing model 130 may be determined, and then a template associated with the target type is used to generate the first set of reference queries, and different numbers of reference queries may be constructed, for example, hundreds or thousands of reference queries, or only a few or tens of reference queries, may be constructed. Each reference query needs to be fully fused into the knowledge of subdivided domain, and such that the processing model 130 can learn specific processing capabilities through these reference queries and corresponding reference answers.

According to an example implementation of the present disclosure, a template of predetermined format may be constructed for each query type, and then the reference query is generated by filling the template, for example, the template may have a format as shown in Table 1 below. At this time, the keyword “Explain” or the like at the start position (or other position) of the template may represent the query type and, in this way, the type and the task type of the generated reference query may be explicitly represented, so that the processing model learns the processing manner for each type of reference query.

TABLE 1
Example of reference query

| Types | Reference query |
|---|---|
| Interpretation Type | Explain . . . |
| Description Type | Describe . . . |
| Summary Type | Summarize . . . |
| Analysis Types | Analyze . . . |
| Diagnosis Type | Trouble-shooting . . . |
| Rewrite Type | Rewrite . . . |
| Generation Type | Generate . . . |

According to an example implementation of the present disclosure, the templates in table 1 may be called and specific tasks to be performed are added at the locations indicated by ellipses, for example, a reference query as shown in Table 2 below may be generated.

TABLE 2
Example of reference query

| Types | Reference query |
|---|---|
| Interpretation | Explain the following terminology. + \n + term |
| Type | |
| Description Type | Describe the details of + content |
| Summary Type | Summarize programming languages |
| Analysis Types | Analyze the following case and give a solution. + \n + |
| | case content |
| Diagnosis Type | Trouble-shooting the provided problem and tell us the |
| | root causes. + \n + problem content |
| Rewrite Type | Rewrite the following codes into the C language. + |
| | \n + text |
| Generation Type | Generate some reasons why some programming |
| | languages are not suitable for . . . |

It should be understood that, although an example of reference query is described above in English and, alternatively and/or additionally, the reference query may be constructed in other natural language and/or custom formats. Specifically, the explanation type reference query represents a certain/some terms that the processing model is expected to explain. As another example, a rewrite type reference query represents that the processing model is expected to write code into a C language, and so forth.

According to an example implementation of the present disclosure, the template may indicate a subdivided knowledge domain involved in the reference query. According to the processing model's problem-solving domain, the domain may be divided into two parts, each part corresponding to one role, and each role may be defined by a corresponding query type. Specifically, for the processing model in the field of software development, the following two roles may be designed for the reference query based on the commands below:

Role 1: You are an assistant answering software development-related questions. Please leverage software development knowledge to solve the following tasks. ###USER: task description ###Assistant: (USER and Assistant are keywords that define the starting and ending positions of a query).

Role 2: You are an assistant answering general questions. Please leverage related knowledge to solve the following tasks. ###USER: task description ###Assistant: (USER and Assistant are keywords that define the starting and ending positions of a query.)

The role 1 specifies the processing model to answer questions related to the software development domain (i.e., the subdivided knowledge domain) using software development related knowledge. The role 2 specifies the processing model to answer general questions (i.e., general knowledge domains) using any relevant knowledge. Specifically, “# # # USER” and “# # # Assistant” may be used as a start-stop identifier of each round of query dialog. After the role is set, a specific reference query may be defined in each role according to the manner shown in Table 2 above.

According to an example implementation of the present disclosure, after a set of reference queries in a certain knowledge domain have been determined, reference answers matching the reference query may be found in the repository 220. In the context of the present disclosure, the specific format of the repository 220 is not limited, and the repository 220 may include various storage manners currently known and/or to be developed in the future. For example, content such as public or internal related knowledge bases, documents, tables and the like related to the subdivided domain knowledge may be collected to obtain the original data set. It should be understood that the various knowledge bases, documents, tables and the like collected herein are all collected with authorization. Various knowledge bases may be utilized, for example, content related to the subdivided knowledge domain may be retrieved or classified from a professional knowledge base in the public domain, and then formatted, and so on. In further, a data set in the vertical domain may be constructed based on information formed in the service such as documents, concept and the like.

According to an example implementation of the present disclosure, a public dataset and a knowledge base may be used. Many open source datasets and knowledge bases are specific to particular domains, such as science and technology, medical, financial, and legal. These resources may serve as starting points for collecting domain knowledge. For example, various existing knowledge bases include a large amount of domain knowledge, which can be used to construct a domain specific model. In the field of software development, information such as a large number of terms, concepts, cases, development system knowledge and the like can be collected through a network and, based on these information, the desired data set may be further constructed.

According to an example implementation of the present disclosure, text mining and topic modeling may be performed in order to extract desired information. Data is collected from sources such as a domain related question and answer community, and key concepts, terms and associations in text can be automatically extracted through text mining and topic modeling to enlarge the knowledge range in the domain.

According to an example implementation of the present disclosure, protocol knowledge and help documents may be analyzed in order to extract desired information. There is a corresponding protocol in each domain, such as various open source protocols in the field of software development, each open source software has a corresponding responsibility and obligation, and a corresponding help document, and these protocols and documents are used as sources of model fine tuning data.

According to an example implementation of the present disclosure, artificial question and answer data may be used in order to extract desired information. Specifically, a question and answer data set related to the domain may be collected, and these data sets include knowledge from a large number of domain experts and practitioners, and may be used to extract and integrate domain information. In case analysis, for example, there may be a large amount of artificial case analysis data, and these data may be collected to construct a final data set.

According to an example implementation of the present disclosure, translation alignment between different natural languages may be performed. For example, some knowledge with few data in a certain language can be expanded to other languages by translation alignment, thereby increasing the diversity of domain knowledge.

With example implementations of the present disclosure, knowledge in multiple domains may be collected in a more comprehensive and richer manner. In this way, the processing model 130 can learn more abundant knowledge, thereby providing a more correct answer.

According to an example implementation of the present disclosure, the answers to the same and/or similar reference query should be consistent in order to prevent instability factors in the training data. At this time, the similarity between each reference query in a set of reference queries can be compared. The distance between each reference query, for example, may be determined based on text analysis and/or semantic analysis. If it is determined that the similarity between the first reference query and the second reference query in the first set of reference queries meets a predetermined condition (e.g. the similarity is greater than or equal to 90% or another threshold), any one of the first reference query and the second reference query may be removed from the first set of reference queries.

With example implementations of the present disclosure, the retrieval of different reference answers for the same and/or similar reference queries may be avoided. In other words, only one reference query is reserved for multiple reference queries that are the same and/or similar. Thus, the reference queries are filtered in advance to ensure that the knowledge learned by the processing model 130 is stable and consistent from the data source.

According to an example implementation of the present disclosure, reference samples may be constructed to train the processing model 130. Specifically, in the process of processing model updating, the target reference sample is created to update the processing model by using the target reference query in the first set of reference queries and the target answer matching the target reference query in the first set of reference answers. In further, the processing model is updated with target reference samples. In this way, reference samples may be continuously constructed under supervision, thereby generating richer and accurate training data for the training processing model. According to an example implementation of the present disclosure, updating processing model may include updating various parameters of the processing model, for example, related parameters, such as weights, of various nodes of the processing model may be updated.

FIG. 4 shows a block diagram 400 for generating a reference sample according to some implementations of the present disclosure. As shown in FIG. 4, a set of reference queries 450 may be created based on the manner described above, and the set of reference queries 450 can include a plurality of reference queries 410, 420, . . . , and 430. Specifically, a reference answer matching each reference query may be searched in the repository 220 to obtain a set of reference answers 460, for example, reference answer 412 matches reference query 410, reference answer 422 matches the reference query 420 . . . reference answer 432 matches the reference query 430 and so on.

In this case, the reference query 410 and the reference answer 412 may be used to construct the reference sample 440. Similarly, reference samples may be constructed with reference query 420 and reference answer 422, . . . , reference samples may be constructed with reference query 430 and reference answer 432 and, in this way, a plurality of reference samples may be generated in a simple and efficient manner, providing richer training data for the processing model 130.

The process of generating reference samples of a particular query type in a particular knowledge domain has been described above. Other query types in the knowledge domain may be processed in a similar manner in order to generate a large number of reference samples of multiple types, as detailed in FIG. 5. FIG. 5 illustrates a block diagram 500 for generating reference samples associated with a given knowledge domain, in accordance with some implementations of the present disclosure. As shown in FIG. 5, knowledge domain 212 relates to software development, and multiple query types 510, . . . , 520, etc., and may be involved in the knowledge domain 212. For example, query type 510 may be a description type, query type 520 may be a generation type, and/or the like.

A set of reference queries may be constructed for each query type, and a reference answer matching each reference query is obtained with repository 220. In further, a group of reference samples may be generated in the manner shown in FIG. 4. In FIG. 5, a set of reference queries 512 may be generated for query type 510, and a set of reference answers 514 that match a set of reference queries 512 may be obtained from repository 220. In further, a corresponding group of reference samples 516 may be generated based on a set of reference queries 512 and a set of reference answers 514.

According to an example implementation of the present disclosure, similar processing may be performed for other query types. Specifically, another target type among a plurality of types may be determined. In further, another template associated with another target type may be utilized to generate a portion of the first set of reference queries associated with another target type.

The right branch in FIG. 5 shows a processing process for another query type. Similar processing may be performed for query type 520 and, for example, a set of reference queries 522 may be generated and a set of reference answers 524 that match a set of reference queries 522 may be obtained from the repository 220. In further, a corresponding group of reference samples 526 may be generated based on a set of reference queries 522 and a set of reference answers 524. In this way, corresponding reference samples may be generated separately for different query types, thereby providing richer training data for the fine tuning process.

According to an example implementation of the present disclosure, in order to ensure that the fine-tuning process is performed based on each query type in a more balanced manner, a not too large quantity difference may be specified for reference samples related to each query type. Assuming that the number of reference samples of a certain query type is too large (e.g.

1,000), overfitting may occur for the query type, and reference samples of other query types with fewer number (e.g. 10) may be ignored.

Since the number of reference samples is the same as that of reference query, that is, in constructing the reference query, it may be specified that the difference between the number of portions in the first set of reference queries associated with the target type and the number of portions in the first set of reference queries associated with another target type meet the predetermined difference condition. In this way, the fine-tuning process can be performed in a more balanced manner to ensure that the updated processing model 130 can answer various query types more comprehensively.

According to an example implementation of the present disclosure, the number of the set of reference queries 512 in FIG. 5 may be the same as or similar to the number of the set of reference queries 522. The predetermined difference condition may, for example, specify that the difference is not higher than 10, or not higher than 1%, and so on.

In further, a group of reference samples 516 and 526 may be used to train the processing model 130. With the example implementations of the present disclosure, a corresponding group of reference samples may be generated for each query type in each knowledge domain, respectively. Richer reference samples may be generated in this way, thereby providing a bountiful knowledge base for the training of processing model 130.

According to an example implementation of the present disclosure, each subdivided knowledge domain in the general knowledge domain may be processed in a similar manner. Specifically, the second knowledge domain in the general knowledge domain may be determined. A second set of reference queries associated with the second knowledge domain may be generated. A second set of reference answers matching the second set of reference queries may be obtained from the repository, and the processing model may be updated using the second set of reference queries and the second set of reference answers.

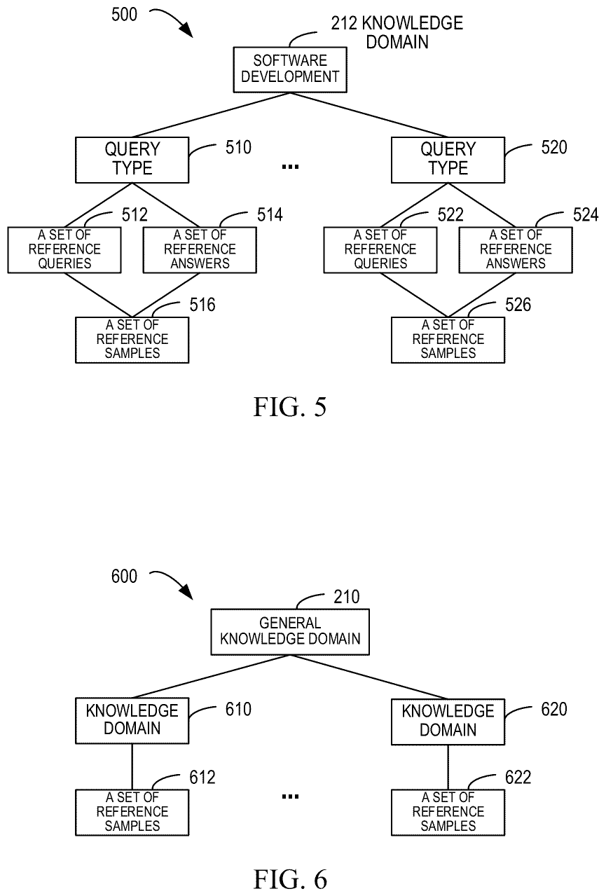

FIG. 6 illustrates a block diagram 600 for generating reference samples associated with various knowledge domains within a general knowledge domain, in accordance with some implementations of the present disclosure. As shown in FIG. 6, corresponding reference samples may be generated in each subdivided knowledge domain in the general knowledge domain 210. Specifically, a group of reference samples 612 may be generated within the knowledge domain 610, and a group of reference samples 622 may be generated within the knowledge domain 620.

It should be understood that the number of user questions within each subdivided domain is different. In order to match the ability of model 130 to answer questions in various subdivided domains with user needs, the number of reference samples (i.e.., the number of reference query) in each subdivided domain may be determined based on the proportion of user questions in various subdivided domains. At this time, the number of the first group of reference queries in the first knowledge domain and the number of the second group of reference queries in the second knowledge domain may be determined based on the number of user queries belonging to the first knowledge domain and the number of user queries belonging to the second knowledge domain.

As shown in FIG. 6, the ratio between the number of the group of reference samples 612 and the number of the group of reference samples 622 is determined based on the number of user queries within knowledge domain 610 and within knowledge domain 620. With the example implementations of the present disclosure, sufficient reference samples may be provided for fine tuning process in a manner consistent with user needs. The processing model 130 updated by using these reference samples can master the knowledge in each subdivided domain, thereby providing a more accurate answer.

It should be understood that, although the examples of refining the processing model in the subdivided domains of software development, hardware design and the like are only shown above by way of example, the technical solutions described above may be performed within any other subdivided domains in the context of present disclosure. Various kinds of knowledge in the knowledge domain such as science and technology, finance, law, music, sports, advertisement, communication and the like, for example, may be collected, and reference queries and reference answers in various domains are used to construct corresponding reference samples, thereby updating the processing model 130 in each knowledge domain.

The reference samples obtained within each of the subdivided knowledge domains may be utilized to update the processing model 130. The processing model 130, for example, after being pre-trained, may be directly trained by using the obtained groups of reference samples. It should be understood that in the training process, knowledge in subsequent reference samples may affect the accumulation of knowledge in the previous reference samples by the processing model 130. The processing model 130, for example, may “forget” knowledge previously learned in the general domain and, at this time, reference samples in the subdivided knowledge domain and reference samples in the general knowledge domain may be mixed.

According to an example implementation of the present disclosure, in the process of processing model updating, at least one general reference sample may be obtained to update the processing model, and the general reference sample includes a reference query and a reference answer in the general knowledge domain. In further, the processing model may be updated by using the target reference sample and at least one general reference sample. The example implementation disclosed herein can be used to alleviate the coverage of general domain knowledge by subdivided domain knowledge.

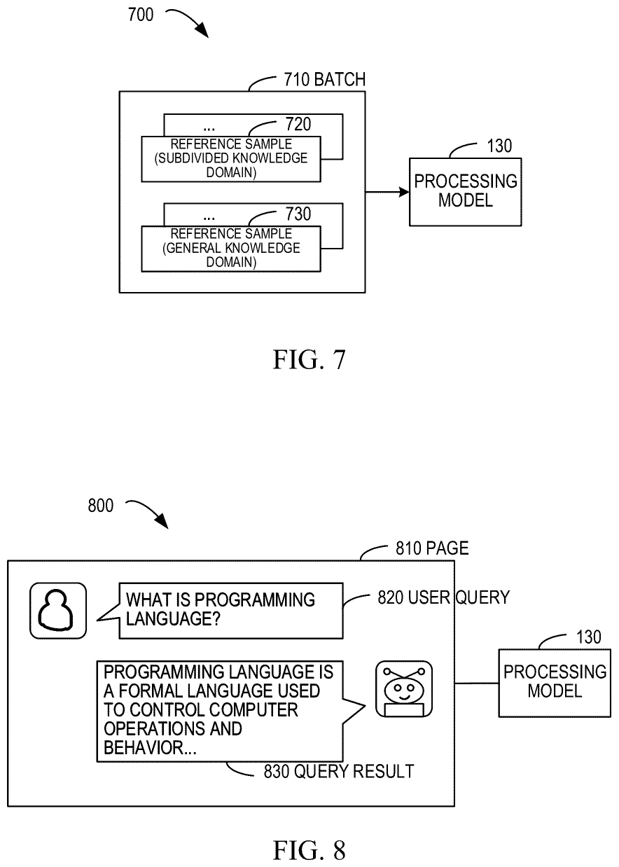

According to an example implementation of the present disclosure, the fine-tuning process may be performed in batch mode. FIG. 7 shows a block diagram 700 for updating a processing model according to some implementations of the present disclosure. As shown in FIG. 7, fine-tuning may be performed in multiple batches, and batch 710 may include reference samples in two different domains: one or more reference samples 720 in the subdivided knowledge domain, and one or more reference samples 730 in the general knowledge domain. In this way, reference samples in different domains may work together on the fine-tuning process and complete processing model 130 updating. At this time, the updated processing model 130 will have knowledge in both the subdivided knowledge domain and the general knowledge domain.

According to an example implementation of the present disclosure, a ratio between the number of target reference samples in the subdivided knowledge domain and the number of at least one general reference sample may meet a predetermined ratio condition. In other words, the ratio between the number of reference samples 720 and the number of reference samples 730 in FIG. 7 may meet a predetermined ratio condition. In general, users may be more inclined to ask questions in general knowledge domains and less likely to ask questions in specific knowledge domains. In this case, the ratio condition may be set according to the ratio of the number of questions in each domain.

For example, the ratio between the number of reference samples 720 and the number of reference samples 730 may be set to 2:8. Alternatively and/or additionally, the ratio between the number of reference samples 720 and the number of reference samples 730 may be set to 1.5:8.5 or others, ensuring that the processing model 130 can master knowledge in various domains in a manner that more conforms to user requirements.

According to an example implementation of the present disclosure, the fine tuning process may be performed with the obtained reference samples based on various ways that are currently known and/or to be developed in the future in order to update the processing model 130. The updated processing model 130 may further be utilized to service user query. Specifically, if a user query for processing model is received, an updated processing model may be used to obtain a query result matching the user query. FIG. 8 provides more information, and illustrates a block diagram 800 for processing a user query with an updated processing model, in accordance with some implementations of the present disclosure.

As shown in FIG. 8, user interaction can be performed in a question-and-answer manner on page 810. Specifically, the user may submit the user query 820 to inquire, for example, “What is the programming language?”, the updated processing model 130 may provide the query result 830 that matches the user query 820 and, at this point, the processing model 130 may provide more knowledge about the programming language and answer questions in a more detailed and accurate manner than before fine-tuning.

According to an example implementation of the present disclosure, it is proposed to construct a fine tuning data set in the subdivided domain, and update the processing model with the fine tuning data set. The data collection in each subdivided domain can help determine reference samples and reference answers in corresponding subdivided domains, and then construct suitable reference samples. In further, balancing the number of reference samples related to query types within each subdivided domain and the number of reference samples within each subdivided domain can help construct a high-quality scalable fine tuning data set. In this way, he processing model can significantly improve its knowledge reserve in related subdivided domain, and further answer related questions in each subdivided domain in a more detailed and accurate manner.

### Example Processes

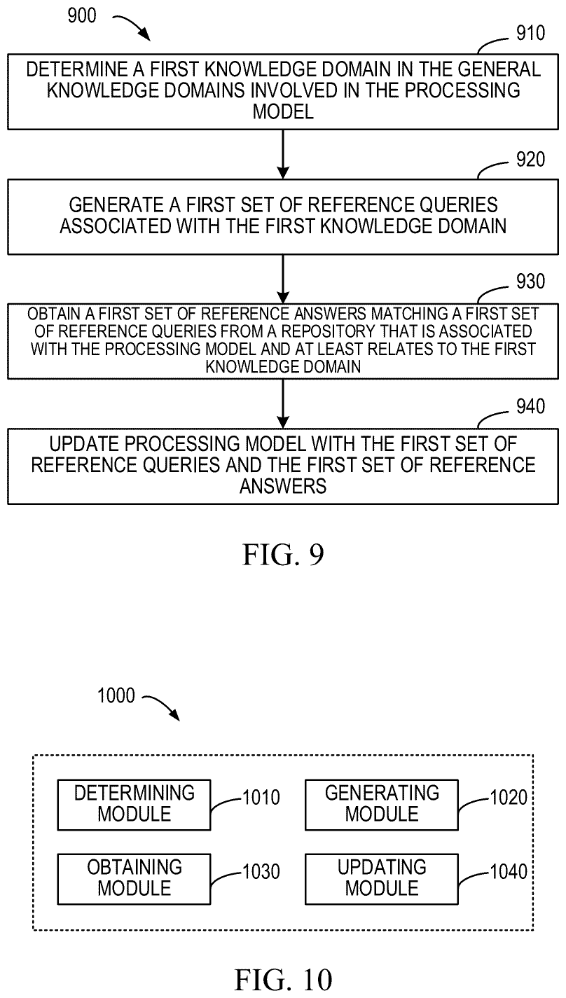

FIG. 9 shows a flowchart of a model processing method 900 according to some implementations of the present disclosure. A first knowledge domain in the general knowledge domains involved in the processing model is determined at block 910, a first set of reference queries associated with the first knowledge domain is generated at block 920, and a first set of reference answers matching a first set of reference queries is obtained at block 930 from a repository that is associated with the processing model and at least relates to the first knowledge domain. The processing model is updated at block 940 with the first set of reference queries and the first set of reference answers.

According to an example implementation of the present disclosure, generating the first group of reference queries includes: determining the target type among multiple types used to input queries into the processing model in the first knowledge domain; and generating the first group of reference queries by using a template associated with the target type.

According to an example implementation of the present disclosure, the template indicates at least one of the following: a first knowledge domain, and a target type.

According to an example implementation of the present disclosure, the method 900 further includes: determining that the similarity between the first reference query and the second reference query in the first set of reference queries meets a predetermined condition, and removing any one of the first reference query and the second reference query from the first set of reference queries.

According to an example implementation of the present disclosure, updating processing model includes: for a target reference query in the first set of reference queries, creating a target reference sample to update the processing model by using the target reference query and a target answer matching the target reference query in the first set of reference answers; and updating the processing model by using the target reference sample.

According to an example implementation of the present disclosure, updating processing model includes: obtaining at least one general reference sample used to update the processing model, wherein the general reference sample includes a reference query and a reference answer in the general knowledge domain; and updating the processing model by using the target reference sample and at least one general reference sample.

According to an example implementation of the present disclosure, a ratio between the number of target reference samples and the number of at least one general reference sample meet the predetermined ratio condition.

According to an example implementation of the present disclosure, generating the first set of reference queries further includes: determining another target type among a plurality of types; and generating a portion of the first set of reference queries associated with another target type by using another template associated with another target type.

According to an example implementation of the present disclosure, the difference between the number of portions associated with target type in the first set of reference queries and the number of portions of the first set of reference queries associated with another target type meets a predetermined difference condition.

According to an example implementation of the present disclosure, the method 900 further includes: determining a second knowledge domain in the general knowledge domain; generating a second set of reference queries associated with the second knowledge domain; obtaining a second set of reference answers matching the second set of reference queries from the repository; and updating the processing model with the second set of reference queries and the second set of reference answers.

According to an example implementation of the present disclosure, the number of the first group of reference queries and the number of the second group of reference queries are determined based on the number of user queries belonging to the first knowledge domain and the number of user queries belonging to the second knowledge domain.

According to an example implementation of the present disclosure, a plurality of types includes at least one of the following: interpretation type, summary type, description type, analysis type, diagnosis type, rewrite type, and generation type.

According to an example implementation of the present disclosure, the method 900 further includes: in response to receiving the user query for the processing model, obtaining a query result matching the user query by using the updated processing model.

### Example Apparatus and Device

FIG. 10 shows a block diagram of a model processing apparatus 1000 according to some implementations of the present disclosure. The apparatus 1000 includes: a determining module 1010, configured to determine a first knowledge domain in the general knowledge domain involved in the processing model; a generating module 1020, configured to generate a first set of reference queries associated with the first knowledge domain; an obtaining module 1030, configured to obtain, from a repository associated with the processing model, a first set of reference answers matching the first set of reference queries, the repository at least involving the first knowledge domain; and an updating module 1040, configured to update the processing model using the first set of reference queries and the first set of reference answers. According to an example implementation of the present disclosure, the generating

module 1020 includes: a type determining module configured to determine, in the first knowledge domain, a target type among a plurality of query input types to the processing model; and a query generation module, configured to generate the first set of reference queries by using a template associated with the target type.

According to an example implementation of the present disclosure, the template indicates at least one of the following: a first knowledge domain, and a target type.

According to an example implementation of the present disclosure, the apparatus 1000 further includes: a removing module, configured to remove any one of the first reference query and the second reference query from the first group of reference query after determining that the similarity between the first reference query and the second reference query in the first group of reference queries meets a predetermined condition.

According to an example implementation of the present disclosure, the updating module 1040 includes: a creating module configured to, for a target reference query in the first group of reference queries, create a target reference sample to update the processing model by using the target reference query and a target answer matching the target reference query in the first group of reference answers; and a model updating module configured to update the processing model by using the target reference sample.

According to an example implementation of the present disclosure, the model updating module includes: a general sample obtaining module, configured to obtain at least one general reference sample to update a processing model, wherein the general reference sample includes a reference query and a reference answer in the general knowledge domain; and a combination updating module, configured to update the processing model by using the target reference sample and at least one general reference sample.

According to an example implementation of the present disclosure, a ratio between the number of target reference samples and the number of at least one general reference sample meets a predetermined ratio condition.

According to an example implementation of the present disclosure, the generation module is further configured to: determine another target type among a plurality of types; and to generate, with another template associated with another target type, a portion of the first set of reference queries associated with another target type.

According to an example implementation of the present disclosure, the difference between the number of portions associated with a target type in the first set of reference queries and the number of portions of the first set of reference queries associated with another target type meets a predetermined difference condition.

According to an example implementation of the present disclosure, the determining module is further configured to determine a second knowledge domain in the general knowledge domain; the generating module is further configured to generate a second set of reference queries associated with the second knowledge domain; the obtaining module is further configured to obtain a second set of reference answers matching the second set of reference queries from the repository; and the updating module is further configured to update the processing model with the second set of reference queries and the second set of reference answers.

According to an example implementation of the present disclosure, the number of the first group of reference queries and the number of the second group of reference queries are determined based on the number of user queries belonging to the first knowledge domain and the number of user queries belonging to the second knowledge domain.

According to an example implementation of the present disclosure, a plurality of types includes at least one of the following: interpretation type, summary type, description type, analysis type, diagnosis type, rewrite type, and generation type.

According to an example implementation of the present disclosure, the apparatus 1000 further includes: a query module configured to, in response to receiving a user query for the processing model, obtain a query result matching the user query by using the updated processing model.

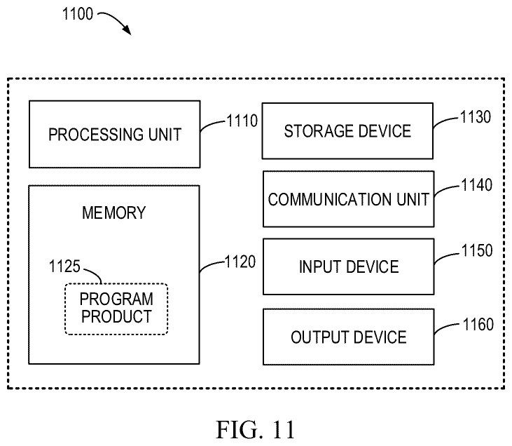

FIG. 11 illustrates a block diagram of a device 1100 capable of implementing various implementations of the present disclosure. It should be understood that the computing device 1100 shown in FIG. 11 is merely exemplary and should not constitute any limitation on the functionality and scope of the implementations described herein. The computing device 1100 shown in FIG. 11 may be configured to implement the method described above.

As shown in FIG. 11, the computing device 1100 is in the form of a general-purpose computing device. Components of the computing device 1100 may include, but are not limited to, one or more processors or processing units 1110, a memory 1120, a storage device 1130, one or more communication units 1140, one or more input devices 1150, and one or more output devices 1160. The processing unit 1110 may be an actual or virtual processor that is capable of performing various processes according to programs stored in the memory 1120. In multiprocessor system, multiple processing units execute computer-executable instructions in parallel to improve the parallel processing capability of computing device 1100.

Computing device 1100 typically includes a plurality of computer storage media, and such media may be any available media accessible by the computing device 1100, including, but not limited to, volatile and non-volatile media, removable and non-removable media. The memory 1120 may be volatile memory (e.g. registers, caches, random access memory (RAM)), non-volatile memory (e.g. read-only memory (ROM), electrically erasable programmable read-only memory (EEPROM), flash memory), or some combination thereof. Storage device 1130 may be a removable or non-removable medium and may include a machine-readable medium, such as a flash drive, magnetic disk, or any other medium, which can store information and/or data (e.g. training data for training) and may be accessed within computing device 1100.

The computing device 1100 may further include additional removable/non-removable, volatile/non-volatile storage media. Although not shown in FIG. 11, a disk drive for reading or writing from a removable, nonvolatile magnetic disk (e.g. a “floppy disk”) and an optical disk drive for reading or writing from a removable, nonvolatile optical disk may be provided. In these cases, each drive may be connected to a bus (not shown in the figure) by one or more data media interface. The memory 1120 may include a computer program product 1125 having one or more program modules, and these program modules are configured to perform various methods or actions in various implementations of the present disclosure.

The communications unit 1140 implements communication with other computing devices over a communication medium. Additionally, components of the computing device 1100 may implement the functions in a single computing cluster, or multiple computing machines capable of communicating over a communication connection. Thus, computing device 1100 may operate in a networked environment using logical connection with one or more other servers, network personal computers (PCs), or another network node.

The input device 1150 may be one or more input devices such as a mouse, a keyboard, a trackball, or the like. The output device 1160 may be one or more output devices, such as a display, a speaker, a printer, or the like. Computing device 1100 may also, as needed, communicate with one or more external devices (not shown in the figure) such as storage devices, display devices, etc., with one or more devices that enable users to interact with computing device 1100, or with any devices (e.g. network card, modem, etc.) that enable computing device 1100 to communicate with one or more other computing devices. Such communication may be performed via an input/output (I/O) interface (not shown in the figure).

According to an example implementation of the present disclosure, a computer-readable storage medium having computer-executable instructions is provided, wherein the computer-executable instructions are executed by a processor to implement the method described above. According to an example implementation of the present disclosure, a computer program product that is tangibly stored on a non-transitory computer-readable medium is further provided, and the computer program product includes computer-executable instructions which are executed by a processor to implement the method described above. According to an example implementation of the present disclosure, a computer program product having a computer program is provided, and the product implements the method described above when the computer program is executed by a processor.

All aspects of the present disclosure are described herein with reference to flowcharts

and/or block diagrams of methods, apparatuses, devices, and computer program products implemented in accordance with the present disclosure. It should be understood that each block of the flowchart and/or block diagram and combinations thereof may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce an apparatus to implement the functions/acts specified in the flowchart and/or block diagram. These computer-readable program instructions can also be stored in computer-readable storage media, and these instructions cause the computer, programmable data processing apparatus, and/or other devices to function in a particular manner, such that the computer-readable medium storing instructions includes a manufactured product, including instructions for implementing various aspects of the functions/actions specified in one or more blocks in the flowchart and/or block diagram.

The computer-readable program instructions may be loaded onto a computer, other programmable data processing apparatus, or other apparatus, such that a series of operational steps are performed on a computer, other programmable data processing apparatus, or other apparatus to produce a computer-implemented process so that the instructions executed on a computer, other programmable data processing apparatus, or other apparatus implement the functions/acts specified in the flowchart and/or block diagram block or blocks.

The flowchart and block diagrams in the attached drawings show the architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions specified in the blocks may also occur in a different order than noted in the figures. the functions indicated in the blocks may also occur in a different order than those indicated in the attached drawings. Two consecutive blocks, for example, may actually be performed substantially in parallel and, in sometimes, may be performed in the reverse order, depending on the functionality involved. It should also be noted that each block in the block diagrams and/or flowchart, as well as combinations thereof, may be implemented by a dedicated hardware-based system that performs the specified functions or actions, or may be implemented by a combination of dedicated hardware and computer instructions.

Various implementations of the present disclosure have been described above, which are examples, not exhaustive, and are not limited to the implementations disclosed. Without departing from the scope and spirit of the various implementations illustrated, many modifications and variations are apparent to those of ordinary skill in the art. The selection of the terms used herein is intended to best explain the principles, practical applications, or technical improvement in the marketplace for the implementations, or to enable others of ordinary skill in the art to understand the various implementations disclosed herein.

I/We claim:

1. A method for processing model comprises:
determining a first knowledge domain in a knowledge domain involved in the processing model;
generating a first set of reference queries associated with the first knowledge domain;
obtaining a first set of reference answers matching the first set of reference queries from a repository associated with the processing model, the repository at least involving the first knowledge domain; and
updating the processing model by using the first set of reference queries and the first set of reference answers.

2. The method of claim 1, wherein generating the first set of reference queries comprises:
determining, in the first knowledge domain, a target type from a plurality of types of query input to the processing model; and
generating the first set of reference queries using a template associated with the target type.

3. The method of claim 2, wherein the template indicates at least one of: the first knowledge domain and the target type.

4. The method of claim 1, further comprising: in response to determining that a similarity between a first reference query and a second reference query in the first set of reference queries meets a predetermined condition, removing any of the first reference query and the second reference query from the first set of reference queries.

5. The method of claim 1, wherein updating the processing model comprises: for a target reference query in the first set of reference queries, creating a target reference sample for updating the processing model by using the target reference query and a target answer matching the target reference query in the first set of reference answers; and
updating the processing model by using the target reference samples.

6. The method of claim 5, wherein updating the processing model comprises:
obtaining at least one general reference sample for updating the processing model, wherein the general reference sample comprises a reference query and a reference answer in the general knowledge field; and
updating the processing model by using the target reference sample and at least one general reference sample.

7. The method of claim 6, wherein a ratio between the number of the target reference samples and the number of at least one general reference sample meets a predetermined scaling condition.

8. The method of claim 1, wherein generating the first set of reference queries further comprises:
determining another target type from a plurality of types; and
generating a portion of the first set of reference queries associated with the other target type by using another template associated with the other target type.

9. The method according to claim 8, wherein a difference between the number of reference queries in the portion of the first set of reference queries associated with the target type and the number of reference queries in the portion of the first set of reference queries associated with the other target type meets a predetermined difference condition.

10. The method of claim 1, further comprising:
determining a second knowledge domain in the general knowledge domain;
generating a second set of reference queries associated with the second knowledge domain;
obtaining a second group of reference answers matching the second group of reference query from the repository; and
updating the processing model by using the second set of reference queries and the second set of reference answers.

11. The method of claim 10, wherein the number of the first set of reference queries and the number of the second set of reference queries are determined based on the number of user queries belonging to the first knowledge domain and the number of user queries belonging to the second knowledge domain.

12. The method of claim 2, wherein a plurality of types comprises at least one of: an interpretation type, a summary type, a description type, an analysis type, a diagnosis type, a rewrite type, a generation type.

13. The method of claim 1, further comprising: in response to receiving a user query for the processing model, obtaining a query result matching the user query by using the updated processing model.

14. An electronic device comprising:
at least one processing unit; and
at least one memory coupled to at least one processing unit and storing instructions for execution by at least one processing unit and the instructions, when executed by at least one processing unit, causes the electronic device to perform a method which comprises:
determining a first knowledge domain in a knowledge domain involved in the processing model;
generating a first set of reference queries associated with the first knowledge domain;
obtaining a first set of reference answers matching the first set of reference queries from a repository associated with the processing model, the repository at least involving the first knowledge domain; and
updating the processing model by using the first set of reference queries and the first set of reference answers.

15. The electronic device of claim 14, wherein generating the first set of reference queries comprises:
determining, in the first knowledge domain, a target type from a plurality of types of query input to the processing model; and
generating the first set of reference queries using a template associated with the target type.

16. The electronic device of claim 15, wherein the template indicates at least one of: the first knowledge domain and the target type.

17. The electronic device of claim 14, wherein the method further comprises: in response to determining that a similarity between a first reference query and a second reference query in the first set of reference queries meets a predetermined condition, removing any of the first reference query and the second reference query from the first set of reference queries.

18. The electronic device of claim 14, wherein updating the processing model comprises: for a target reference query in the first set of reference queries, creating a target reference sample for updating the processing model by using the target reference query and a target answer matching the target reference query in the first set of reference answers; and
updating the processing model by using the target reference samples.

19. The electronic device of claim 18, wherein updating the processing model comprises:
obtaining at least one general reference sample for updating the processing model, wherein the general reference sample comprises a reference query and a reference answer in the general knowledge field; and
updating the processing model by using the target reference sample and at least one general reference sample.

20. A computer-readable storage medium having stored thereon a computer program which, when executed by a processor, causes the processor to:
determine a first knowledge domain in a knowledge domain involved in the processing model;
generate a first set of reference queries associated with the first knowledge domain;
obtain a first set of reference answers matching the first set of reference queries from a repository associated with the processing model, the repository at least involving the first knowledge domain; and
update the processing model by using the first set of reference queries and the first set of reference answers.
